(19) United States
(12) Patent Application Publication
(10) Pub. No.: US 2011/0171866 A1
(43) Pub. Date: Jul. 14, 2011

(54) Fire Resistant Coating and Method

(76) Inventor: Paul Craig Scott, Houston, TX (US)

(21) Appl. No.: 13/120,416

(22) PCT Filed: Sep. 22, 2009
(86) PCT No.: PCT/US09/57910

§ 371 Date: Mar. 22, 2011

Related U.S. Application Data
(60) Provisional application No. 61/099,477, filed on Sep. 23, 2008.

(51) Int. Cl. B32B 5/02; B32B 29/02; D04B 1/12; D03D 15/00

(52) U.S. Cl. 442/189; 156/176; 442/308; 442/307

(57) ABSTRACT

A fire resistant coating system comprises an adhesive substrate coating material, a support structure including curvilinear fibers having randomly oriented loops and curls to provide reinforcement for a fire resistant coating, and a fire resistant coating. A method for installing such a material includes an adhesive application step, a support structure application step, and a coating application step.

### CROSS-REFERENCE TO RELATED APPLICATIONS

This application claims the benefit of Provisional Application No. 61/099,477 filed Sep. 23, 2008, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

1. Field of the Invention

This invention relates generally to fire resistant coatings, and more particularly to a fire resistant coating including an intumescent material, a support structure for supporting the intumescent material and a related method.

2. Description of the Related Art

The prior art teaches use of an intumescent fire resistant coating with a support structure.

Fire resistant coatings are useful for application to substrates to protect the substrate from extreme temperatures.

Fire resistant coatings often include char-forming compositions. For example, Ward et al. U.S. Pat. No. 4,529, 467 teaches a fire resistant coating composition that produces a carbonaceous char. Intumescent coatings expand to form an insulating char structure upon exposure to sufficient heat. Intumescent coatings may swell to produce a char that is more than five times the original coating thickness. Such expansion, however, results in cracking and fissures in the coating structure, and often, separation of some or all of the coating from the substrate to be protected.

To prevent the char from falling off the substrate to be protected, a support structure may be provided.

The differential temperature rise as a function of time across a sample substrate at specified conditions provides a measure of a coating's effectiveness in protecting a substrate from extreme temperatures.

U.S. Pat. No. 3,913,290 to Castle, et al. describes an insulated reinforcement for use on structural members. The reinforcement is supported on the structural member and the fireproofing material placed thereabout. The reinforcement secures an insulation strip against the end of the structural flange. Fireproofing material is applied over the mesh and insulation strip to cover the flanges and webs of the structural member. The reinforcement may be constructed of a mesh-like member.

U.S. Pat. No. 5,443,991 to Boyd, Jr., et al., discloses a hybrid mesh fabric to reinforce char resulting from a fire and to prevent or reduce fissures in the mastic fire resistant coating. The 991 Patent describes a fabric containing a high temperature fibrous material with interweaving of a less-expensive low temperature fibrous material with the high temperature fiber.

U.S. Pat. No. 4,069,075 to Billings, et al describes a structural support for char residue derived from a char forming intumescent coating on a structural member. The structural support includes a fire resistant mesh member attached to the structural member. A char forming intumescent coating is applied to the structural member so as to substantially encapsulate the entire mesh member so that the char residue, when formed, encapsulates the mesh member and is anchored to the structural member thereby. The mesh member is a wire mesh or a mesh formed from another fire resistant material.

U.S. Pat. No. 5,580,648 to Castle, et al., discloses reinforcement for mastic intumescent fire protection coatings comprising free-floating carbon mesh embedded in the coating, or optionally, using carbon mesh with mechanically attached reinforcements. The 648 Patent teaches use of carbon mesh as an alternative to more expensive and more rigid welded wire mesh.

U.S. Pat. No. 7,001,857 to Degroote teaches a fabric made of yarns containing basalt fibers with sizing agents and a polyester polyurethane coating fabric face layer.

### BRIEF SUMMARY OF THE INVENTION

Accordingly, it is an object to provide a fire resistant coating with a support structure including curvilinear fibers having randomly oriented loops and curls to provide reinforcement for a fire resistant coating. The present invention teaches the use of such material as well as a method for installing such a material.

### BRIEF DESCRIPTION OF THE DRAWINGS

For a more complete understanding of the present invention and the advantages thereof, reference is now made to the following Detailed Description of an Example Embodiment of the Invention, taken in conjunction with the accompanying drawings, in which:

FIG. 1 depicts a support structure including curvilinear fibers having random loops and curls.

FIG. 2 depicts a detailed view of interconnected fibers and a support structure including curvilinear fibers having random loops and curls.

FIG. 3 depicts a cross-sectional detail of a fire resistant coating system.

FIG. 4 depicts a partial cross-sectional detail of a fire resistant coating system.

FIG. 5 depicts an alternate embodiment cross-sectional detail.

### DESCRIPTION OF THE INVENTION

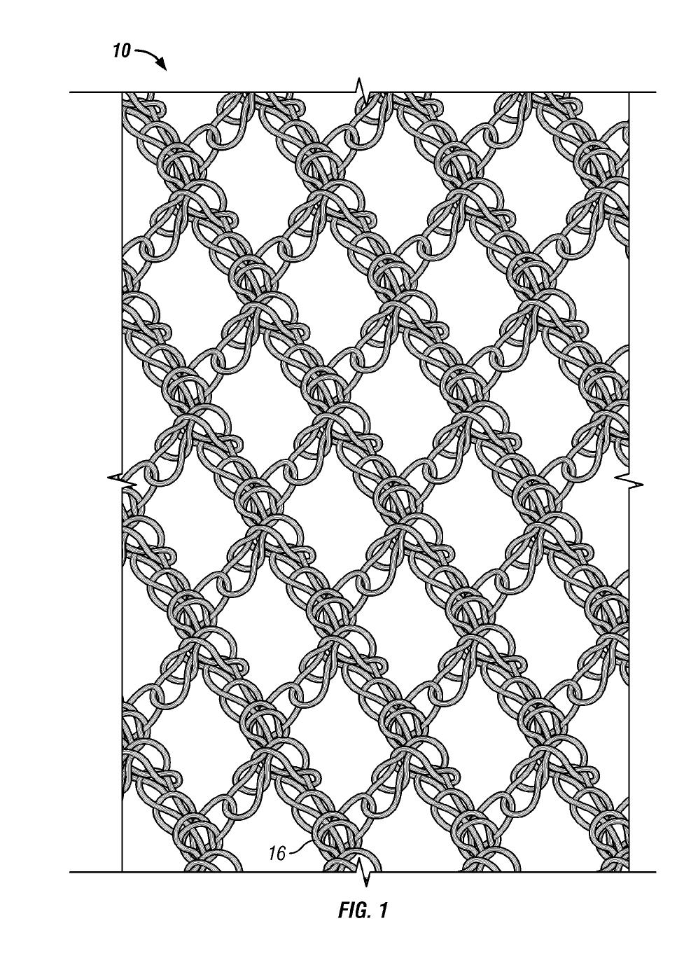

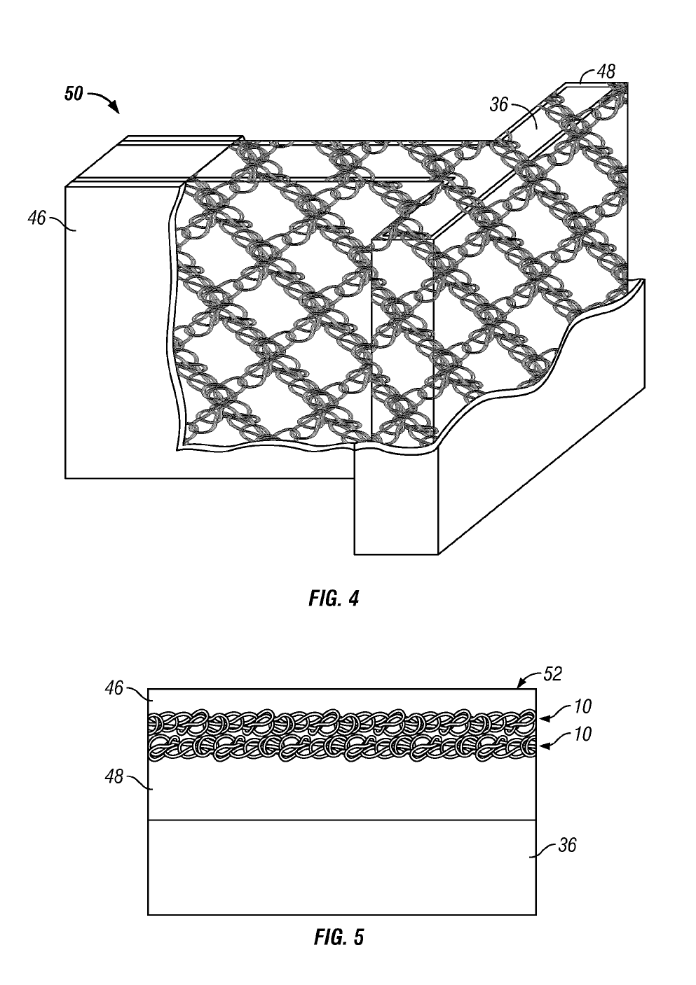

The invention and its advantages are best understood by referring to the drawings, like numerals being used for like and corresponding parts of the various drawings. FIGS. 1-3 show an exemplary embodiment of the present invention. FIG. 4 depicts an installed fire resistant coating and support structure, generally designated as 50.

Referring to FIGS. 1-3, a support structure including curvilinear fibers having random loops and curls (hereinafter structure 10), an adhesive material 48, and a fire resistant coating 46 are depicted.

Adhesive material 48 may be known mastic or other appropriate adhesive. The fire resistant coating 46 may be formed from an appropriate intumescent coating known in the art or other appropriate fire resistant coating.

Referring to FIG. 1, support structure 10 includes curvilinear looped fibers including loops 28 and curls 32.

Structure 10 comprises a plurality of curvilinear fibers 16 having randomly oriented loops 28 and curls 32. In an exemplary embodiment curvilinear fibers 16 comprise continuous filaments. A fiber 16 may comprise a single filament or, alternatively, may comprise a plurality of filaments.

In an exemplary embodiment fiber 16, whether a single filament or a plurality of filaments, is twisted, such twisting resulting in a curvilinear fiber 16 structure generally described as loops 28 and curls 32. Curls 32 may be coincident with and included in loops 28.

By continuous filament, it is meant that a filament of fiber 16 is substantially elongated in relation to its width, generally having a length of more than 100 times its diameter.

Multiple fibers 16 are used in a support structure 10. In the example of a knitted structure 10, differing fibers 16 would be used by different threading needles or threading bars. In the example of a woven or knitted structure 10, differing fibers 16 would be used for warp and weft. From place to place within the structure a fiber 16 may end and the structure 10 continued by another fiber 16.

The curvilinear structure with loops 28 and curls 32 allows expansion and contraction of the structure 10 responsive to biasing forces.

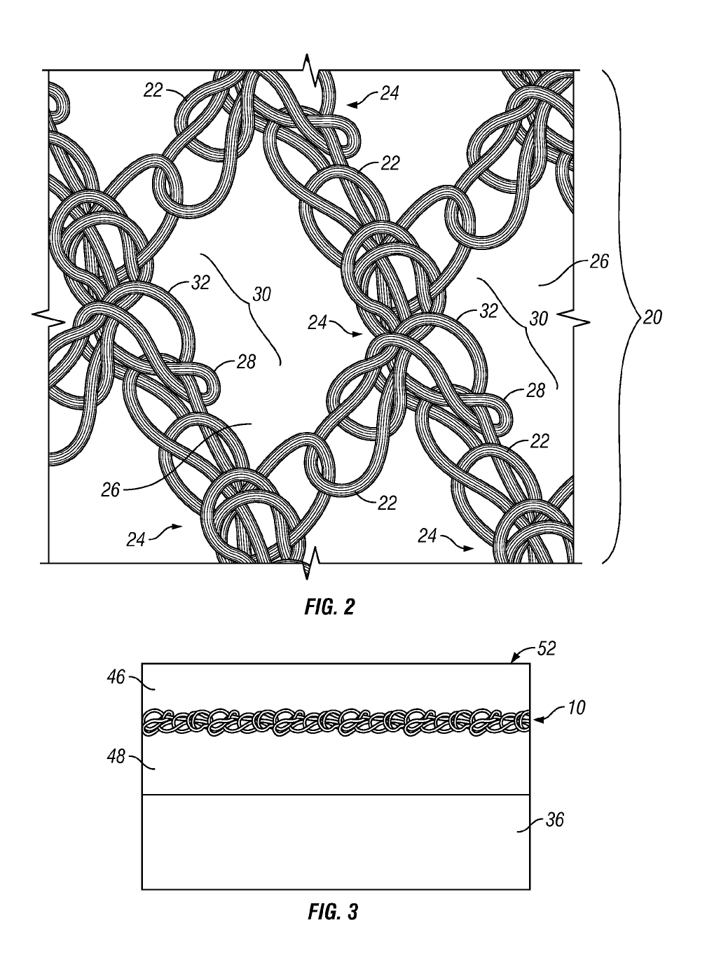

Referring to FIG. 2, an exemplary embodiment depicts an exemplary geometric arrangement of structure 10. In this embodiment, randomly looped fibers 16 are arranged to form a generally regular pattern of a plurality of quadrilateral fiber structures 20, each structure 20 having four (4) sides 22 and four (4) vertices 24. The vertices 24 are the points where the respective sides 22 meet each other.

Still referring to FIG. 2, in the exemplary embodiment shown, the sides 22 frame an opening 26 with a lateral dimension of approximately 0.95 cm (0.375 inch). Such dimension is approximate as to any particular side 22 due to the irregular structure of randomly looped fibers 16.

Curvilinear fibers 16 are continuous fibers throughout structure 10.

As shown in FIG. 2 fibers 16 include multiple curvilinear segments 30, defining a plurality of loops 28 and curls 32. Loops 28 and curls 32 allow the flexible fiber 16 to be biased wherein the any particular curvilinear segment 30 is elongated or compressed. Such elongation or compression may be alternately described as stretched or compressed. Such curvilinear structure of fibers 16 further allows for differential elongation or compression of fibers 16 within a section of a support structure 10 without adversely affecting other sections of support structure 10.

Segments of each loop 28 define planes. Segments of each curl 32 define planes. The various planes defined by individual loops 28 and curls 32 extend angularly in relation to each other and accordingly are intersecting planes. Accordingly, loops 28 and curls 32 define multiple intersecting planes.

The curvilinear structure of fibers 16 further allows for support structure 10 to be formed and moved in multiple planes, allowing it to be formed around a substrate 36 having intersecting planes. The curvilinear structure of fibers 16 including loops 28 and curls 32 further allow movement of support structure 10 responsive to expansion of coating 46 or adhesive material 48 upon exposure of such coating 46 and adhesive material 48 to extreme temperatures.

Referring to FIG. 4, an installation of an installed fire resistant coating 46 and support structure 10 is depicted in relation to an underlying substrate 36, here a section of an I-beam. Substrate 36 has an adhesive material 48 over its surface. An embodiment of structure 10 is placed over the adhesive material 48 on substrate 36. A fire resistant coating 46 is placed over structure 10. As can be seen, structure 10 is able to conform to the surface of the substrate 36 bending around the corners of the various surfaces of the substrate 36.

Such ready conformance results from the flexibility of fibers 16, together with the curvilinear structure of fibers 16 including loops 28 and curls 32.

Fibers 16 are sufficiently rigid to provide a support structure for the coating 46. At installation, coating 46 is fluidic. Upon curing of the coating 46, coating 46 adheres to fibers 16 as well as to adhesive material 48. Accordingly, upon curing of coating 46, adhesive material 48, support structure 10 and coating 46 form a coating system 50 attached to substrate 36.

Upon occurrence of an extreme thermal condition in relation to substrate 36 and coating system 50, intumescent coating 46 will expand and form a char. The charred coating 46 will include multiple cracks and fissures. While curvilinear fibers 16 expand and contract responsive to the changed condition of the charred coating 46, the continuity of fibers 16 maintain structural stability of the coating system 46, preventing separation that would otherwise occur. This results in part from the flexibility of the fibers 16 and in part from the increased surface area contact of the fibers 16 with coating 46 and adhesive material 48.

Referring to FIG. 3, a partial side view depicts the support structure 10 installed with protective coating 46 and adhesive material 48 on a substrate 36. The support structure 10 is intertwined within both protective coating 46 and adhesive material 38 with segments of protective coating 46 contained within loops 28 and curls 32 of protective coating 46.

The multiple loops 28 and curls 32 of the fibers 16 create a multi-dimensional honeycomb effect. In particular, segments of coating 46 fill in spaces within loops 28 and curls 32. Upon expansion (intumescence) of the coating 46 in response to extreme heat, such segments remain within the loops 28 and curls 32 thus aiding in retention of the ensnared char segment and attached char segments within structure 10.

An exemplary fiber 16 material includes a basalt fiber comprising basalt with or without sizing. Basalt fibers are generally first formed with a sizing material. Sizing is a starch, oil, wax, or other suitable organic ingredient applied to a fiber strand to protect the fiber and to aid in handling. Conventional sizing compositions contain ingredients to provide lubricity and binding action.

An exemplary sizing material contains a silane coupling agent.

An exemplary type of basalt that may be used to form the fibers 16 includes tholeiitic basalt.

An exemplary support structure 10 comprises a knitted structure 10, the structure 10 formed by a known knitting process. An exemplary knitting process is described in U. S. Pat. No. 3,447,345 to Kurz, titled knitted mesh fabric, the teachings of which are incorporated herein by reference. The knitted fabric resulting from application of the teachings of such patent results in a fabric that, upon the application of tension forms an open mesh appearance, each opening having a diamond shaped configuration.

A knitted support structure 10 utilizing fibers 16 comprising curvilinear segments 30 comprising loops 28 and curls 32 provide support structure 10 provides multiple randomly oriented loops 28 and curls 32.

Referring to FIG. 5, in an alternative embodiment of the present invention, two layers of support structure 10 are provided within the fire resistant coating system 50. A first layer of support structure 10 is provided intermediate adhesive material 48 and intumescent coating 46 and a second layer of support structure 10 is provided proximate the surface 52 of coating 46.

In an alternative embodiment of the present invention, adhesive material 48 comprises a fire protective coating that is either the same material as coating 46 or a different type of fire protective coating.

In a test of a fire protective coating system 50 of the present invention, steel plates (300 mm×300 mm×5 mm) were coated with an intumescent coating. The plates were held at 75° C. for an extended prior to the test. A brick furnace was used. The furnace structure enabled two propane jet nozzles to be directed at a test plate on the coated surface and also prevented any flames from making contact with the back surface of the steel. A thermocouple was arranged to measure the temperature of the flame. Two thermocouples were in contact with the back surface of the steel. Data was recorded. The thickness of the coating and the name of the intumescent coating and support structure were recorded. The jets were ignited and operated to reach and maintain a temperature of 1100° C. The test was continued as to each sample until the back surface of the steel plate reached a temperature of 400° C. or for a time period of 60 minutes, whichever occurred earlier. Thickness of the resultant char was recorded for each plate and observations were made.

Referring to FIG. 5, an alternative embodiment comprises providing two layers of the support structure 10 of the present invention to a substrate 36, with the second layer located proximate the surface 52 of said coating 46.

For tests using the basalt material as the support structure, the following observations were made:

| | Thick- | Thick- | | Time for |
|---|---|---|---|---|
| | ness | ness | | Steel to |
| | Before | after | Obser- | Reach |
| Coating | Test | Test | vations | 400° C. |
| Intumescent top coat with | 7 mm | 25 mm | Coating | 31 |
| two layers of mesh: | | | came | minutes |
| 1 layer woven basalt mesh | | | detached | |
| (with bi-directional | | | from steel | |
| warp and weft weave and | | | and was | |
| lacking curvilinear loops | | | alight after | |
| and curls) at 50% thickness | | | jets were | |
| and 1 layer on the surface | | | turned off | |
| Intumescent top coat with | 5 mm | 20 mm | Some | 26 |
| 1 layer knitted | | | sagging | minutes |
| basalt mesh reinforcement | | | on top edge, | |
| (with curvilinear loops | | | char intact, | |
| and curls) at 50% thickness | | | alight after | |
| | | | test stopped | |
| Intumescent top coat with two | 7 mm | 50 mm | Soft and | 59 |
| layers of mesh: 1 layer knitted | | | sticky | minutes |
| basalt mesh at 50% thickness | | | before test. | |
| and 1 layer knitted basalt | | | Char intact. | |
| mesh at the surface (with | | | | |
| curvilinear loops and curls) | | | | |

A method for installation of the fire resistant coating system 50 comprises an adhesive material 48 application step, a support structure 10 placement step and a coating 46 placement step. The adhesive material application step comprises applying adhesive material 48 to a substrate 36. The support structure 10 attaching step consists of placing the support structure 10 including curvilinear fibers having random loops and curls 16 on the substrate 36 and adhesive material 48 with structure 10 pressed against the adhesive material 48 to adhere in a desired pattern to the substrate 36. During the support structure 10 attaching step support structure 10 should be molded to conform to the various surfaces of the underlying substrate 36. The coating 46 placement step consists of applying a fire resistant coating 46 over the surface of the underlying substrate 36 and thereby over the adhesive material 48 and over the support structure 10. The coating 46 placement step may be performed once or may be repeated multiple times.

In an alternate method, a second support structure 10 application step comprises applying a second support structure 10 to substrate 36 by placing second support structure 10 in coating 46 proximate surface 52 of coating 46.

Although various exemplary embodiments have been shown and described, the invention is not limited to the embodiments shown. No single embodiment is representative of all aspects of the invention.

I claim:

1. A support structure for a fire resistant coating, comprising: a plurality of flexible curvilinear fibers;
each said plurality of fibers formed to have a plurality of randomly-oriented loop segments;
each said plurality of fibers formed to have a plurality of randomly oriented curls; and
said plurality of curvilinear fibers formed in an interconnected pattern.

2. The support structure of claim 1 wherein:
said plurality of loops defining intersecting planes.

3. The support structure of claim 2 wherein:
said plurality of curls defining intersecting planes.

4. The support structure of claim 3 wherein:
said interconnected pattern comprising a woven structure.

5. The support structure of claim 3 wherein:
said interconnected pattern comprising a knitted structure.

6. The support structure of claim 3 wherein:
each said plurality of fibers comprising at least one twisted fiber filament.

7. The support structure of claim 3 wherein:
said adhesive material comprises the same compound as said fire protective coating.

8. The support structure of claim 1 wherein:
each said at least one twisted fiber filaments at least partially comprising basalt.

9. The support structure of claim 8 wherein:
each said at least one twisted fiber filaments at least partially comprising basalt and at least partially comprising a sizing compound.

10. A fire resistant coating system for application to a substrate, comprising:
an adhesive material for application to a substrate;
a support structure for application to said adhesive material distal said substrate;
a fire resistant coating for application to said support structure distal said substrate;
said support structure comprising a plurality of flexible curvilinear fibers;
each said plurality of fibers formed to have a plurality of randomly oriented loop segments;
each said plurality of fibers formed to have a plurality of randomly oriented curls; and
said plurality of curvilinear fibers formed in an interconnected pattern.

11. The fire resistant coating system of claim 10 wherein:
said plurality of loops defining intersecting planes.

12. The fire resistant coating system of claim 11 wherein:
said plurality of curls defining intersecting planes.

13. The fire resistant coating system of claim 11 wherein:
said interconnected pattern comprising a woven structure.

14. The fire resistant coating system of claim 11 wherein:
said interconnected pattern comprising a knitted structure.

15. The fire resistant coating system of claim 12 wherein:
each said plurality of fibers comprising at least one twisted fiber filament.

16. The fire resistant coating system of claim 12 wherein:
said adhesive material comprises the same compound as said fire protective coating.

17. The fire resistant coating system of claim 15 wherein:
each said at least one twisted fiber filaments at least partially comprising basalt.

18. The fire resistant coating system of claim 17 wherein:
each said at least one twisted fiber filaments at least partially comprising basalt and at least partially comprising a sizing compound.

19. A method for applying a fire resistant coating to a substrate, comprising: a plurality of flexible curvilinear fibers;
an adhesive material application step comprising applying an adhesive material to the substrate,
a support structure placement step comprising applying a support structure having curvilinear fibers formed in random loops and curls to said adhesive material; and
a coating placement step comprising applying a fire resistant coating to said adhesive material and said support structure distal said substrate.

20. The method of claim 19, further comprising:
a support structure molding step comprising molding said support structure to conform to said substrate.

21. The method of claim 19, further comprising:
a second support structure placement step comprising applying a second support structure to said fire protective coating proximate a surface of said fire protective coating.
